(19) United States
(12) Patent Application Publication
(10) Pub. No.: US 2020/0137984 A1
(43) Pub. Date: May 7, 2020

(54) A FARM SYSTEM WITH POSITION DETERMINATION FOR ANIMALS

(71) Applicant: Nedap N.V., Groenlo (NL)

(72) Inventors: Rudie Jan Hendrik Lammers, Eibergen (NL); Ingo Henricus Clemens Wassink, Eibergen (NL); Jort Johannes Wilhelmus Schutte, Nieuw Heeten (NL)

(73) Assignee: Nedap N.V., Groenlo (NL)

(21) Appl. No.: 16/628,283

(22) PCT Filed: Jul. 5, 2018
(86) PCT No.: PCT/NL2018/050442

§ 371 Date: Jan. 3, 2020

(30) Foreign Application Priority Data
Jul. 5, 2017 (NL) 2019186

(51) Int. Cl. A01K 29/00; A01K 11/00; A01K 1/00; A01K 7/02; A01K 5/02

(52) U.S. Cl. CPC A01K 29/005; A01K 11/006; A01K 5/02; A01K 7/02; A01K 1/0023

(57) ABSTRACT

Farm system comprising an area where animals can be, a position determining system to record where at least one animal is and what the identity is of that animal, and a computer system which is communicatively coupled with the position determining system, wherein, in use, the computer system receives information from the position determining system about at least one record of where the at least one animal is and what the identity, wherein the area comprises a multiplicity of subareas, wherein the computer system is provided with information about the subdivision of the area into the subareas and wherein the computer system is configured to process the information received from the position determining system in combination with the information about the subdivision of the area into subareas for obtaining new information and for generating an output signal which represents at least a part of the new information.

### SUMMARY OF THE INVENTION

The invention relates to a farm system comprising an area where animals can be, a position determining system to record where at least one animal is and what the identity is of that animal, and a computer system which is communicatively coupled with the position determining system, wherein, in use, the computer system receives information from the position determining system about at least one record of where the at least one animal is and what the identity is of that animal.

Such a system is known per se. The object of the invention is to expand the functionality of the known system. According to the invention, to that end, the farm system is characterized in that the area comprises a multiplicity of subareas, wherein the computer system is provided with information about the subdivision of the area into the subareas and wherein the computer system is configured to process the information received from the position determining system in combination with the information about the subdivision of the area into subareas for obtaining new information and for generating an output signal which represents at least a part of the new information. With the utilization according to the invention of the phenomenon of subareas as claimed, the foundation is laid for obtaining relevant new information.

In particular, it holds here that a subarea, at least for a part, is virtually bounded. However, a subarea can also be a physically bounded space in which the at least one animal can be. In this regard, think, for example, of a lying space. At least one subarea may also be associated with an implement intended for an animal that is in such subarea. In this regard, think, for example, of a subarea in which a trough is placed from which an animal can eat or a subarea in which an animal has to be present to be able to eat from a trough which is set up just outside the subarea. In that case too, the subarea concerned may at least for a part be virtually bounded; however, the subarea can also be (wholly) physically bounded. In particular, it holds that the farm system comprises a multiplicity of subareas, with the computer system being configured to determine, for example as new information in the output signal, how frequently and/or how long the at least one animal is in any one of the respective subareas. According to a practical variant, it holds that the farm system comprises at least one lying subarea, standing/walking subarea, milking subarea, eating subarea, drinking subarea, calving subarea and/or separation space subarea. In that case, the computer system may for example be configured to determine, for example as new information in the output signal, how long an animal is in the lying subarea as an indication of the lying time of the animal and/or wherein the computer system is configured to determine, for example as new information in the output signal, how long an animal is in the standing/walking subarea as an indication of the standing and walking time and/or standing and walking frequency and/or standing and walking pattern of the animal and/or wherein the computer system is configured to determine, for example as new information in the output signal, how long an animal is in the milking subarea as an indication of the milking time and/or milking frequency and/or milking pattern of the animal and/or wherein the computer system is configured to determine as new information how long an animal is in the eating subarea as an indication of the eating time and/or eating frequency and/or eating pattern of the animal and/or wherein the computer system is configured to determine, for example as new information in the output signal, how long an animal is in the drinking subarea as an indication of the drinking time and/or drinking frequency and/or drinking pattern of the animal and/or wherein the computer system is configured to determine, for example as new information in the output signal, how long the at least one animal is in the calving subarea as an indication of the calving time of the animal and/or wherein the computer system is configured to determine, for example as new information in the output signal, how long the at least one animal is in the separation space subarea as an indication of the mobility of the animal. More generally, it holds moreover that at least one subarea is a place where the at least one animal can be and the place being associated with an implement of the farm system such as a gate, an automatic feeder, a milking plant.

In particular, it holds here that the computer system is configured to determine, for example as new information in the output signal, how frequently and/or how long each time and/or how long overall the at least one animal makes use of, and/or is in the vicinity of, one of the implements.

All of the above-mentioned new information is of particular interest to a farmer to be able to analyze and monitor the status of his herd.

According to a particular aspect of the invention, it holds that the computer system is provided with the identity of a predetermined group of animals, wherein the group of animals is lower in rank than other animals, and wherein the computer system is configured to determine in respect of this group, for example as new information in the output signal, whether the animals avoid particular subareas or places. This allows any problem in the herd to be spotted, for example when animals of the group that are lower in rank cannot or dare not present themselves at a feeding trough.

In particular, it holds that the computer system is configured to recognize animals which, on average over time, comparatively often join a queue of animals at the rear, and to add thus-recognized animals, for example as new information in the output signal, to a group of animals which are lower in rank. In this manner a group of animals which are lower in rank can be determined.

Also, it is possible that the computer system is configured to determine what an average mutual distance between respective pairs of animals is, to determine, for example as new information in the output signal, what the hierarchy of the animals is by determining from which animal or animals, according to a predetermined criterion, on average the greatest distance is kept by the other animals and/or to determine what the hierarchy of the animals is by determining, according to a predetermined criterion, which animal keeps or which animals keep on average a greatest distance from the other animals, for example to determine a group of animals which on average keep a relatively great distance from other animals and to assign these particular animals, for example as new information in the output signal, to a group of animals that are lower in rank. In this manner too, such a group can be determined.

It also holds, according to a particular embodiment, that the computer system is configured to determine in what average order animals enter a subarea, in order to determine, for example as new information in the output signal, what the hierarchy of the animals is and/or to determine a group of animals, for example as new information in the output signal, which is lower in rank, this group consisting of animals which on average stand comparatively closer to the rear in the order. In this manner too, a group of animals which is lower in rank can be determined.

In particular, it holds furthermore that the computer system is provided with the identity of a multiplicity of animals, wherein the computer system is configured to determine the movement of individual animals of this group of animals to establish, for example as new information in the output signal, how frequently passages of the farm system are used by the multiplicity of animals. From this, it may for example be derived whether there are any particular obstacles in passages that can lead to hazardous situations.

Furthermore, it holds in particular that the computer system is configured to determine the absence of an animal in a barn as an indication, for example as new information in the output signal, that the animal is grazing.

According to a particular embodiment, it holds furthermore that the farm system includes a multiplicity of spaces in which animals can be, wherein the position determining means are configured to determine of each animal of a multiplicity of animals where the animal is and what its identity is, wherein in the computer system at least one predetermined group of animals is recorded, which group is part of the multiplicity of animals, and wherein the computer system is configured to determine, for example as new information in the output signal, whether the animal is in a subspace in which there are also other animals and whether a number of those other animals and the animal belong to the at least one group.

In this manner, the behavior of the animals can be controlled well. If the group consists, for example, of a group of animals which are lower in rank, it can be ascertained whether this group of animals stay together or that there is an animal that separates itself from this group and hence, as a result, is going to exhibit deviant behavior. Likewise, of course, the group of animals can be a group of relatively higher-ranking animals. In this manner, it can be determined if, perhaps, there is an animal that exhibits deviant behavior and no longer joins up with this group of animals, for example because the animal is sick.

### DESCRIPTION OF THE DRAWING

The invention will presently be further elucidated with reference to the drawing. In the drawing:

### DETAILED DESCRIPTION OF THE INVENTION

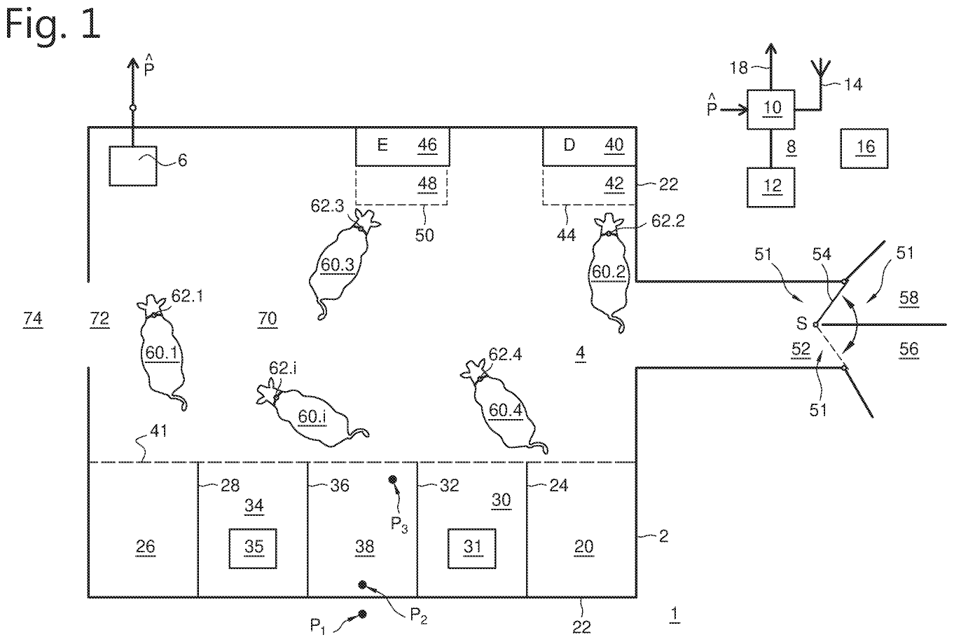

FIG. 1 shows a possible embodiment of a farm system according to the invention.

The farm system 1 includes a barn 2 which encloses an area 4 where animals can be. The farm system further includes a schematically represented position determining system 6 to record where, in this example, a multiplicity of animals are, and what the identity is of the animals concerned. The information about the determined position and identity of the animals is designated in the drawing by the letter \hat{P}. The system furthermore includes a computer system 8 which is communicatively coupled with the position determining system 6. This is indicated in the drawing in that the signal \hat{P} is supplied to the computer system 8. In this example, the computer system 8 comprises a signal processing unit 10 and a data storage memory 12. The computer system 8 further includes a schematically indicated transmitting device 14 in order to send out new information which has been generated by the computer system for receipt by, for example, a mobile phone 16 of a farmer. It is also possible, however, that the new information is supplied via a fixed line 18 to, for example, a fixedly disposed monitor or a fixed computer set up elsewhere.

In this example, the farm system further includes a first lying subarea 20 which, as shown in the drawing, is bounded for a part by a wall 22 and a fence 24. The farm system further includes a second lying subarea 26 which is bounded by the wall 22 and a fence 28. Further, the farm system includes a first milking subarea 30 which is bounded by a fence 24 and a fence 32. Furthermore, the system includes a second milking subarea 34 which is bounded by the fence 28 and a fence 36. The milking subarea 30 is provided with an implement in the form of an automatic milking unit 31 with which a cow can be milked. The milking subarea 34 is provided with an implement in the form of an automatic milking unit 35 with which the animal can be milked.

Furthermore, the farm system includes a calving subarea 38 which is bounded by the fences 36 and 32. The subareas 20, 26, 30, 34, 38, furthermore, are each virtually bounded by the broken line 41.

The farm system further includes a water trough 40. Bounding this water trough 40 is a subarea which is bounded by the wall 22 and the water trough 40 and which, furthermore, is virtually bounded as indicated with the broken line 44. It holds, therefore, that the subarea 42 is associated with the water trough 40. Further, the farm system comprises an automatic feeder 46 and a subarea 48 which is bounded by the automatic feeder 46 and is virtually bounded by a broken line 50. It holds, therefore, that the subarea 48 is associated with the automatic feeder 46. Accordingly, the subareas 42 and 48 are thus virtual subareas.

The farm system further includes a separation space subarea 51 which is provided with a separation gate 54 which in a first position places a partial subarea 52 in communication with a further partial subarea 56 as shown in the drawing and in a second position, which is indicated in dots in the drawing, places the partial subarea 52 in communication with a partial subarea 58.

In the farm system, there are, in this example, a number of animals 60.i (1=1, 2, 3 . . . N), each animal being provided with its own smart tag 62.i. With the aid of the position determining system 6 it can be determined which smart tag 62.i is where in the farm system. Accordingly, of these animals, the position and identity can thus be determined. In the data storage system 12, information is stored about the subdivision of the area 4 into the subareas mentioned. This is understood to mean, in this example, that the position of each subarea in the farm system is known. As, furthermore, the position of each animal can be determined with the aid of the position determining system and the smart tag 62.i, it can be determined whether an animal is in a particular subarea. For completeness, it is noted that it is also possible that it is determined per subspace whether an animal is in the respective subspace. In such a system, each subspace may for example be provided with a sensor which determines whether a smart tag 62.i is in the respective subspace. In that case, it is not necessary that the position of the subareas is known in the data storage system 12. It is only necessary that the existence of the subarea is known so that it can be established whether an animal is in the respective subarea. In that case, the position determining system is still configured to determine where the animal is, in the sense that determining where the animal is, then is not related to a particular position within the farm system or a particular position within the barn, but is related to the presence of the animal in a particular subarea. Accordingly, recording where the animal is can therefore be the recording of a position within a barn, in which case the positions of the subareas are also known, or the recording of the presence of an animal within a subarea, in which case it is not necessary then that the positions of the subareas within the barn are also known.

However this may be, in use, the computer system receives information from the position determining system about where an animal is and what the identity of the animal is. In this example, this is carried out for a multiplicity of animals. The computer system, as has been mentioned, is provided with information about the subdivision of the area into the subareas. This information is stored in the data storage memory 12. The signal processing unit 10, and hence the computer system 8, is configured to process the information received from the position determining system 6 in combination with the information about the subdivision of the area into subareas, for obtaining new information and for generating an output signal which represents at least a part of the new information. In this example, it holds that the computer system is configured to determine, as new information, how frequently and/or how long an identified animal is in any one of the respective subareas. This gives a farmer relevant information. Thus, for example, it can be established whether an animal avoids particular subareas. When, for example, the animal presents itself at an automatic feeder only briefly or not at all, it may be sick. This also holds true when the animal presents itself only briefly, or infrequently, at the water trough 40, which can be established in that it is not often or only briefly in the respective subarea. Accordingly, this also holds for the virtual subarea 48 which is associated with the automatic feeder. When the animal is not often or only briefly at the automatic feeder, this can also be indicative of deviant behavior. Conversely, presenting regularly at the automatic feeder or at the water trough can also be indicative of deviant behavior that is relevant for the farmer.

Such conclusions can also be drawn on the basis of the non-virtual subareas such as the first lying subarea 20. When an animal lies in the lying subarea too often or too long, this may be indicative of deviant behavior. The same then holds also for the lying subarea 26. When the animal does not present itself in one of the milking subareas 30 or 34 in order to be milked, this may also be indicative of deviant behavior. Likewise, dwelling in the milking subarea at a low frequency and/or only briefly may be indicative of deviant behavior. All this new information can be supplied to the farmer. If the animal is in the (entrance) partial subarea 52 for a long time, while the separation gate 54, for example, provides access to one of the partial subareas 56 or 58, this can also indicate deviant behavior, for example, that the animal is little mobile and keeps on standing in the partial subarea 52 too long. In this example, the farm system furthermore comprises a standing and walking subarea 70. In respect of a standing/walking subarea, it can be recorded whether the animal stands and/or walks a lot, which can be used to monitor whether the animal exhibits normal or deviant behavior.

In this example, it holds furthermore that the computer system 8 is provided with the identity of a predetermined group of animals 60.i where the group of the animals has been determined beforehand and is lower in rank than the rank of other animals. A low rank in this example is understood to involve animals that are submissive to other animals which have a higher rank. The computer system in this example is configured to determine of this group of animals, as new information, whether the animals avoid particular subareas (places or spaces). If this is the case, it may be that, for instance, other animals are so dominant that the animals of the group of lower rank dare not or cannot present themselves in the subarea 42 to drink or in the subarea 48 to eat, anymore. This is important information for a farmer. Also, the computer system may be configured to determine a group of animals that have a lower rank. In the preceding example, this group had been determined beforehand, and hereinafter it is indicated how this group can be determined beforehand. The computer system may be configured, for example, to recognize animals which, on average over time, relatively often join a queue of animals at the rear, for example a queue going to one of the milking subareas 30, 34. This information about animals that join a queue of animals relatively often at the rear concerns new information on the basis of which a group (of low-ranking animals) can be compiled or which can be added to an existing group (of low-ranking animals). This information can then also be supplied to the farmer in that, for example, the farmer asks for information about the identity of the respective group of animals which has been stored by the computer system, for example in data storage memory 12. Also, the computer system may be configured to determine what the average mutual distance between respective pairs of animals is. Accordingly, it can for instance be determined, as new information in the output signal, what the hierarchy of the animals is by determining from which animal, on average, the greatest distance is kept by the other animals. This particular animal is then high in the hierarchy. It is also possible, however, to determine the hierarchy of the animals by determining which animal keeps the greatest distance from the other animals. These determinations can be carried out according to a predetermined criterion. On the basis of this information too, a group of relatively low-ranking animals and a group of relatively high-ranking animals can be defined. Obviously, a middle group can thus be defined as well. The outcome of these determinations may, as new information, be supplied to the farmer, for example. It is also possible that the computer system is configured to determine in what average order animals enter a subarea, to determine, for example as new information in the output signal, what the hierarchy of the animals is or to determine a group of animals which is lower in rank, this group consisting of animals which are comparatively closer to the rear in the order. In this example, it holds furthermore that the computer system is provided, in the data storage memory 12, with an identity of each of a multiplicity of animals. The computer system is configured to determine the movement of these individual animals to establish how frequently passages of the farm system are used by the multiplicity of animals. This information can for example be supplied as new information in the output signal to the farmer with the aid of the transmitting device 14 or the fixed line 18. This can provide the farmer with insight, for example about possible blockades of particular passages. In this example, the computer system is further configured to determine over what distance an identified animal moves within a predetermined period of time. In consequence, it can be determined whether the animal is estrous when the distance per period of time has exceeded a predetermined value. That the animal is possibly estrous can in turn be supplied as new information to the farmer again. For determining the distance the animal has covered, it holds, in particular, that such distance also comprises a walking to and fro to walk from a first position to a second position. Accordingly, the computer system is configured to determine the distance the animal has covered to walk from a first position to a second position. This does not need to be the distance between the first and second position if the animal has walked to and fro along the path that has been covered to walk from the first to the second position. The computer system is furthermore so configured that it calculates a distance for the animal to get from a first position to a second position along a path which the animal can walk, taking physical boundaries within the area into account. Accordingly, the distance is not always the shortest distance between the two positions. Sometimes, an animal has to walk a way round to be able to get from a first position to a second position because the two positions are separated from each other by an object such as a wall or fence. In that case, the distance to be taken is the path that must have been followed by the animal walking a way round. This can be effected by determining the position of the animal continuously or, for example, with a high frequency such as once every second. In that case, the path the animal covers, and hence the distance the animal covers, can be determined well.

It is also possible that in the data storage memory 12 an attention list is included of animals in respect of which a deviation has been established. In this example, the computer system is configured to delete an animal from the attention list, for example as new information in the output signal for the farmer, when the respective animal is in a predetermined subarea. If, for example, an animal that was sick presents itself again in the subarea 42 to drink, in the subarea 48 to eat and/or in one of the subareas 30 and 34 to be milked, the animal may, for example, be declared healthy again and be removed from the attention list of unhealthy animals.

The computer system in this embodiment is also configured to determine the absence of the animal in the area 4, that is, the area comprised by the barn. In that case, the animal will have left the barn via an opening 72 of the barn to a meadow 74 and this is an indication that the animal is grazing. This indication can for example be supplied to the farmer as new information again. The computer system is also configured to record and process the movement of animals along or through subspaces for obtaining information about the animals, for example, which passages in a barn are used relatively often or relatively little. This information can be supplied as new information to the farmer again. If particular passages are used more often or less often, such as, for example, the passage 72, this can again be indicative of, for example, a blockade. In this example, it holds furthermore that the farm system includes a multiplicity of spaces in which the animals can be. In this regard, think, for example, of the subareas 20, 26, 34, 30, 38, 42 and 48. The position determining means are configured to determine, of each animal of a multiplicity of animals, for example the animals 60.1-60.n, where the animal is and what its identity is. In the computer system a predetermined group of animals is recorded, which group is part of the multiplicity of animals. The computer system is configured to determine whether the animal is in a subspace where there are also other animals and whether a number of those other animals and the animal belong to the at least one group. If the group consists of animals of a comparatively higher rank, it can be established whether an animal that is also of higher rank is with its group. If this proves to be not so, this can be indicative of a deviation. Also, a group can consist of animals of a comparatively lower rank. Then too, it can be established whether an animal that is in the proximity of other animals, is an animal of lower rank while the other animals also belong to a group of lower rank. In other words, it is determined whether the animal is with its own group. All this determined information can again be supplied as new information to the farmer. If the computer system records that the animal is at a first position P1 where the animal cannot actually go (for example because the area where the animal can be is physically bounded and the first position P1 is outside that area), the computer system corrects this position according to a predetermined algorithm to a second position P2 where the animal can be. In this example, the first position P1 is outside a barn space where the animal can be. The algorithm can then, for example, look for a second position P2 which is within the area where the animal can be, with the distance between the first position and the second position being minimal. From all possible second positions P2, then, the position P2 is chosen that is closest to the first position P1. It is also possible that the computer system ignores the first position P1 and preferably then assumes that the animal is at a position P3 where the animal was before the first position P1 was measured. The position P3 is then a position that is possible, otherwise it would (also) have been ignored.

The invention is not in any way limited to the embodiment outlined above. Thus, the barn may be arranged differently and may be provided with other known implements that interact with the animals, such as a milking robot, a weighing unit and the like. Such variants are each understood to fall within the scope of the invention.

1. A farm system comprising an area where animals can be, a position determining system to record where at least one animal is and what the identity is of that animal, and a computer system which is communicatively coupled with the position determining system, wherein, in use, the computer system receives information from the position determining system about at least one record of where the at least one animal is and what the identity is of that animal, wherein in that the area comprises a multiplicity of subareas, wherein the computer system is provided with information about the subdivision of the area into the subareas and wherein the computer system is configured to process the information received from the position determining system in combination with the information about the subdivision of the area into subareas for obtaining new information and for generating an output signal which represents at least a part of the new information.

2. The farm system according to claim 1, wherein at least one subarea is at least for a part virtually bounded and/or that the subarea is at least for a part physically bounded.

3. The farm system according to claim 1, wherein at least one subarea is an at least for a part physically bounded space in which the at least one animal can be and/or that at least one subarea is associated with an implement intended for an animal which is in that subarea.

4. The farm system according to claim 1, wherein the farm system comprises a multiplicity of spaces in which animals can be, wherein the position determining means are configured to determine, of each animal of a multiplicity of animals, where the animal is and what its identity is, wherein in the computer system at least one predetermined group of animals is recorded, which group is part of the multiplicity of animals and wherein the computer system is configured to determine as new information in the output signal, whether the animal is in a subspace in which there are also other animals and whether a number of those other animals and the animal belong to the at least one group.

5. The farm system according to claim 1, wherein the farm system comprises a multiplicity of subareas, wherein the computer system is configured to determine as new information in the output signal, how frequently and/or how long the at least one animal is in one of the respective subareas.

6. The farm system according to claim 1, wherein the farm system comprises at least one lying subarea, standing/walking subarea, milking subarea, eating subarea, drinking subarea, calving subarea and/or separation space subarea.

7. The farm system according to claim 6, wherein the computer system is configured to determine as new information in the output signal, how long an animal is in the lying subarea as an indication of the lying time of the animal and/or wherein the computer system is configured to determine as new information in the output signal, how long an animal is in the standing/walking subarea as an indication of the standing and walking time and/or standing and walking frequency and/or standing and walking pattern of the animal and/or wherein the computer system is configured to determine as new information in the output signal, how long an animal is in the milking subarea as an indication of the milking time and/or milking frequency and/or milking pattern of the animal and/or wherein the computer system is configured to determine as new information in the output signal, how long an animal is in the eating subarea as an indication of the eating time and/or eating frequency and/or eating pattern of the animal and/or wherein the computer system is configured to determine as new information in the output signal, how long an animal is in the drinking subarea as an indication of the drinking time and/or drinking frequency and/or drinking pattern of the animal and/or wherein the computer system is configured to determine as new information in the output signal, how long the at least one animal is in the calving subarea as an indication of the calving time of the animal and/or wherein the computer system is configured to determine as new information in the output signal, how long the at least one animal is in the separation space subarea as an indication of the mobility of the animal.

8. The farm system according to claim 6, wherein the standing subarea is provided with a partition such as a wall and/or fence which bounds the standing subarea, the milking subarea is provided with an implement in the form of a milking device to milk an animal, the calving subarea is provided with a partition such as a wall and/or fence which bounds the calving subarea, the separation space subarea is provided with an entrance subarea, a first partial subarea and a second partial subarea and an implement in the form of a separation gate which in a first position provides access to the first partial subarea from the entrance subarea and in a second position provides access to the second partial subarea from the entrance subarea, and/or an eating subarea is provided with an implement in the form of an automatic feeder and/or trough.

9. The farm system according to claim 1, wherein at least one subarea is a place where the at least one animal can be and the place being associated with an implement of the farm system such as a gate, an automatic feeder, or a milking device.

10. The farm system according to claim 9, wherein the computer system is configured to determine as new information in the output signal, how frequently and/or how long each time and/or how long overall the at least one animal makes use of and/or is in the vicinity of one of the implements.

11. The farm system according to claim 9, wherein at least one place is associated with a trough, automatic feeder and/or milking device.

12. The farm system according to claim 1, wherein the computer system is provided with the identity of a predetermined group of animals, wherein the group of animals is lower in rank than that of other animals and wherein the computer system is configured to determine this group of animals as new information in the output signal, whether the animals avoid particular subareas or places.

13. The farm system according to claim 1, wherein the computer system is configured to recognize animals which, on average over time, join a queue of animals relatively often at the rear and to add thus-recognized animals as new information in the output signal, to a group of animals which are lower in rank.

14. The farm system according to claim 1, wherein the computer system is configured to determine what an average mutual distance between respective pairs of animals is, to determine as new information in the output signal, what the hierarchy of the animals is by determining relative to which animal or relative to which animals, according to a predetermined criterion, on average the greatest distance is maintained by the other animals and/or to determine what the hierarchy of the animals is by determining, according to a predetermined criterion, which animal or which animals on average maintains or maintain a greatest distance from the other animals to determine a group of animals which on average maintain a relatively great distance from other animals and to assign these determined animals as new information in the output signal, to a group of animals which are lower in rank.

15. The farm system according to claim 1, wherein the computer system is configured to determine in what average order animals enter a subarea, in order to determine as new information in the output signal, what the hierarchy of the animals is and/or to determine a group of animals as new information in the output signal, which is lower in rank, such group consisting of animals which on average are comparatively closer to the rear in the order.

16. The farm system according to claim 1, wherein the computer system is provided with the identity of a multiplicity of animals, wherein the computer system is configured to determine the movement of individual animals of this group of animals to establish as new information in the output signal, how frequently passages of the farm system are used by the multiplicity of animals.

17. The farm system according to claim 1, wherein the computer system is configured to determine over what distance the at least one animal moves within a predetermined period of time, to determine as new information in the output signal, whether the animal is estrous when the distance has exceeded a predetermined value, wherein, in particular, said distance also comprises a walking to and fro to walk from a first position to a second position.

18. The farm system according to claim 1, wherein in the computer system an attention list is included of animals in respect of which a deviation has been established and wherein the computer system is configured to delete an animal from the attention list as new information in the output signal, when the respective animal is in a predetermined subarea.

19. The farm system according to claim 1, wherein the computer system is configured to determine the absence of an animal in a barn, as an indication as new information in the output signal, that the animal is grazing.

20. The farm system according to claim 1, wherein the computer system is configured to record and process the movement of the animals along or through the subspaces, for obtaining information as new information in the output signal, about the animals which passages in a barn are used relatively often or relatively little.

21. The farm system according to claim 1, wherein if the computer system records that the animal is at a first position where the animal cannot go, the computer system corrects this position according to a predetermined algorithm to a second position where the animal can be or that the computer system ignores the first position and then preferably assumes that the animal is at a position where the animal was before the first position was measured.

22. The farm system according to claim 1, wherein the computer system calculates a distance for the animal to get from a first position to a second position along a path which the animal can walk, taking physical boundaries within the area into account.
